(19) United States
(12) Patent Application Publication
(10) Pub. No.: US 2026/0316585 A1
(43) Pub. Date: Oct. 15, 2026

(54) SYSTEMS AND METHODS FOR CONTROLLING A PROPULSION VEHICLE

(71) Applicant: TGCI LLC, Troy, NY (US)

(72) Inventor: Stephen A. HOYT, Castleton, NY (US)

(73) Assignee: TGCI LLC, Troy, NY (US)

(21) Appl. No.: 19/644,778

(22) Filed: Apr. 10, 2026

Related U.S. Application Data
(60) Provisional application No. 63/786,477, filed on Apr. 10, 2025.

(51) Int. Cl. B60L 7/10

(52) U.S. Cl. CPC B60L 7/10; B60L 2240/12; B60L 2250/26

(57) ABSTRACT

A system for use in propelling a vehicle includes an accelerator sensor for detecting a pressure on an accelerator by a user in a first vehicle. A second vehicle controller is connectable between the accelerator sensor and a first vehicle controller of the first vehicle configured to control a driving mechanism of the first vehicle. A second vehicle has a propelling vehicle controller connected to the second vehicle controller and configured to control a driving mechanism of the second vehicle. The second vehicle is configured to apply a force to the first vehicle to propel the first vehicle. The second vehicle controller is configured to send a communication to the propelling vehicle controller in response to receiving a signal from accelerator sensor detecting a pressure on the accelerator by the user to change a speed of the second vehicle.

### CROSS REFERENCE TO RELATED APPLICATIONS

This application claims priority to U.S. Provisional Application No. 63/786,477 filed on Apr. 10, 2025, entitled “DESCRIPTION OF CONTROL SYSTEMS FOR A SELF-POWERED DRIVERLESS VEHICLE USED TO PROPEL OTHER VEHICLES AND CHARGING OF ELECTRIC VEHICLES AND AN AUTOMATIC CONNECTION/DOCKING DEVICE FOR MULTIPLE CONNECTED USES”, which is incorporated herein by reference in its entirety.

This application is related to U.S. application Ser. No. ______ (attorney docket no. 5982.001B), filed on the same day as this application, and titled SYSTEMS AND METHODS FOR CONNECTING VEHICLES which is incorporated herein by reference in its entirety.

### TECHNICAL FIELD/AREA

This invention relates in general to electrical vehicles, and in particular, to systems and methods for providing supplemental propulsion to a vehicle.

### BACKGROUND OF THE INVENTION

Drivers of vehicles powered by gas or diesel currently have no options for propelling such a vehicle with electric propulsion without an expensive conversion of the vehicle drivetrain. For those with full battery electric vehicles, driving range, charge times and access to charging infrastructure remains a concern particularly when a non-local or intercity trip is undertaken. Additionally, electric vehicle range can be dramatically reduced at high speeds or when towing a vehicle such as a trailer or other vehicle. This may increase the need to charge the electric vehicle frequently and cause significant travel delays.

Thus, a need exists for systems and methods for supplemental propulsion of non-electric vehicles and to increase a range of an electrically powered passenger vehicle.

### SUMMARY OF THE INVENTION

The present invention provides, in a first aspect, a method for use in propelling a vehicle which includes a first vehicle controller controlling a first driving mechanism of a first vehicle to control a movement of the first vehicle. A second vehicle controller of the first vehicle sends a propelling signal to a propelling vehicle controller of a second vehicle to cause the second vehicle controller to control a second driving mechanism to move the second vehicle to apply a force to the first vehicle.

The present invention provides, in a second aspect, a system for use in propelling a vehicle which includes an accelerator sensor for detecting a pressure on an accelerator by a user in a first vehicle. The first vehicle has a first vehicle controller. A second vehicle controller is connectable between the accelerator sensor and the first vehicle controller of the first vehicle. The first vehicle controller is configured to control a driving mechanism of the first vehicle. A second vehicle has a propelling vehicle controller configured to control a driving mechanism of the second vehicle. The propelling vehicle controller is connected to the second vehicle controller. The second vehicle is configured to apply a force to the first vehicle to propel the first vehicle. The second vehicle controller is configured to send a communication to the propelling vehicle controller in response to receiving a signal from accelerator sensor detecting a pressure on the accelerator by the user. The propelling vehicle controller is configured to control the driving mechanism of the second vehicle to change a speed of the second vehicle in response to the propelling vehicle controller receiving the communication from the second vehicle controller.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a side view [to be added] a lead vehicle connected to a propelling vehicle by a vehicle connection system in accordance with the present invention;

FIG. 2 is a block diagram view of a speed control and communication system for controlling the lead vehicle and propelling vehicle of FIG. 1;

FIG. 3 is block diagram view of the speed control and communication system of FIG. 2 showing messages for controlling the lead vehicle and propelling vehicle of FIG. 1; and

FIG. 4 is a flow chart showing a control of the lead vehicle and propelling vehicle of FIG. using the speed control and communication system of FIG. 2.

### DETAILED DESCRIPTION OF THE INVENTION

In accordance with the principles of the present invention, systems and methods for controlling a propulsion vehicle are provided.

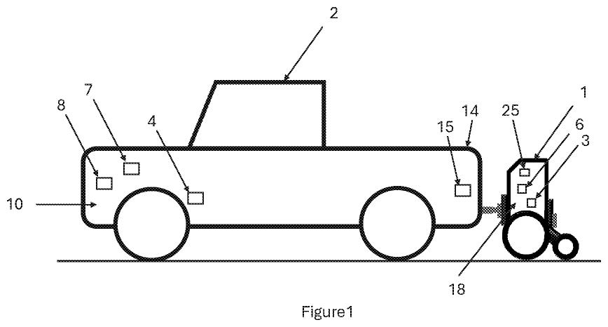

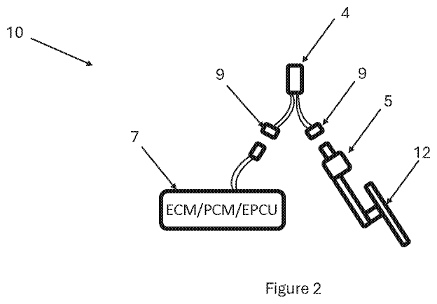

As depicted in FIGS. 1-2, a self-powered, driverless propulsion vehicle 1 may be used to propel a towing position vehicle or lead vehicle 2 and thereby reduce the energy needs of lead vehicle 2.

Lead vehicle 2 may include a driving mechanism or engine 8 for causing movement thereof. Lead vehicle 2 may be an electrically powered vehicle with a regenerative braking system that may recharge a battery (not shown) of the vehicle when the vehicle is braking or slowing. Lead vehicle 2 may include an internal combustion engine powered by fuels such as gasoline or diesel as a sole or supplemental driving engine. Propulsion vehicle 1 may similarly include an internal combustion engine (not shown) and/or an electric motor (not shown) coupled to an electric battery (not shown).

Propulsion vehicle 1 may be configured to provide a force to move or assist in a movement of lead vehicle 2. Propulsion vehicle 1 may be attachable to, or may be configured to provide such a force while contacting but not attached to, lead vehicle 2. A force provided by propulsion vehicle 1 to lead vehicle 2 (when lead vehicle 2 includes an electric motor) may increase a stored battery energy of electric vehicle via a regenerative braking system that normally recharges the battery when the vehicle is braking or slowing. Recharging the battery of an electrically powered lead vehicle (e.g., lead vehicle 2) occurs when the electric lead vehicle is being propelled by the propulsion vehicle (e.g., propulsion vehicle 1) and the regenerative braking system is partially engaged as is often true during normal operation of many electric vehicle types. Recharging of the battery via regenerative braking while under propulsion may require additional propulsion energy from the self-powered propulsion vehicle beyond the energy required to propel both vehicles.

A speed of lead vehicle 2 when pushed or propelled by propulsion vehicle 1 may be controlled via a plug-in or a vehicle integrated speed control and communication system or by the use of an application (e.g., a smartphone or tablet computer application) for controlling a speed of propulsion vehicle 1 and lead vehicle 2, for example. Such a plug-in or vehicle integrated speed control and communication system may require an installation of a plug-in controller module or integration of a similar control process into the programming for control systems of the lead vehicle 2. Such an integration may occur when developing the control systems design of a new vehicle. In contrast, controlling the speed of such a propulsion vehicle (e.g., propulsion vehicle 1) via an application may require only downloading the application to a smart phone or tablet computer, for example.

Modern vehicles generally use an accelerator pedal position sensor to communicate a position of a driver's foot on an accelerator pedal 12 to a vehicle's control systems to control a speed of the vehicle. For example, as the driver of a vehicle depresses or lifts off the accelerator pedal, an accelerator pedal position sensor 5 (FIG. 2) may generate voltages within a known range specific to the make and model of vehicle. Normally these voltage signals are sent to a vehicle's control system or controller which, among other functions, controls the vehicles'speed and acceleration and which may be referred to as an engine control module (ECM), Powertrain Control Module (PCM) or in the case of an electric vehicle, the Electric Power Control Unit (EPCU). The voltages received by such a vehicle controller (e.g., ECM/PCM/EPCU) from the accelerator pedal position sensor indicate if the driver desires to maintain, increase or decrease vehicle speed.

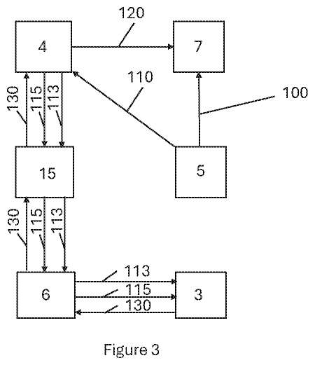

A speed control and communication system 10 may include a lead vehicle controller module 4 in lead vehicle 2 and a propelling controller module 3 in propulsion vehicle 1 as depicted in FIGS. 1-2, for example. Lead vehicle controller module 4 may be a plug-in controller module installed in lead vehicle 1 (FIG. 2) between accelerator pedal position sensor 5 and a vehicle controller 7 (e.g., ECM/PCM/EPCU). Lead vehicle controller module 4 may intercept a voltage signal 100 generated by accelerator pedal position sensor 5 as signal 100 would otherwise be sent to vehicle controller 7 via plug portions 9 of lead vehicle controller module 4 that connects to both accelerator pedal position sensor 5 and vehicle controller 7 (e.g., via a wired or wireless connection). An intercepted voltage signal 110 may be sent to controller module 4 from accelerator pedal position sensor 5 and is a same signal that would otherwise be sent to controller 7 but is referred to herein as intercepted signal 110 when directed to controller module 4. Intercepted signal 110 may then be processed or transmitted by lead vehicle controller module 4 to propelling control module 3 in propulsion vehicle 1, as depicted in FIG. 3, for example. Such a connection may be wired or may be wireless radio, infrared, laser, microwave, light or other wireless signal transmission (e.g., BLUETOOTH) from lead vehicle controller module 4 of lead vehicle 2 to a receiver 6 in controller module 3 in propulsion vehicle 1.

The described connection between propelling controller module 3 and controller module 4 may be directly between lead vehicle controller module 4 and propelling controller module 3 as described above or a transmitter 15 may be coupled to controller module 4 on lead vehicle 2 and may be located remotely from control module 4. For example, transmitter 15 may be located at a rear 14 of lead vehicle 2 as depicted in FIG. 1 and may be connected via a wired or wireless connection to lead vehicle control module 4 as described above relative to lead vehicle control module 4 and propelling controller module 3. Receiver 6 may be wired or wirelessly connected to propulsion controller module 3 in propulsion vehicle 1 and may similarly be located at a front 18 or another appropriate location in propulsion vehicle 1. For example, lead vehicle controller 4 may send a voltage signal to transmitter 7 which may forward the signal to receiver 6 which may forward the signal to propelling controller module 3 which may act on the signal by increasing or lowering a speed of propulsion vehicle 1 or providing more or less force from propulsion vehicle 1 to lead vehicle 2. Transmitter 15 and receiver 6 described above may be configured to act as both a transmitter to send the messages described above and as a receiver to receive such messages.

For example, when connecting lead vehicle controller module 4 to accelerator pedal position sensor 5 via plug portions 9 in lead vehicle 2, a specific make and model of lead vehicle 2 may be entered either directly into module controller 4 or via a phone application remotely connected (e.g., wirelessly vis BLUETOOTH) to controller module 4. Lead vehicle controller module 4 may also detect voltage ranges and voltage profiles used by an accelerator sensor of a make and model of a vehicle when plug portions 9 are connected to accelerator pedal position sensor 5 and the user activates an accelerator without the necessity for a user to input such information. Lead vehicle controller module 4 may be pre-programmed (prior to such a connection) with appropriate accelerator pedal position sensor voltage ranges for a range of vehicle makes and models to allow system 10 to be utilized with various vehicle makes and models. Such accelerator pedal position sensor voltage ranges for most vehicles are generally linearly proportional to most other vehicles.

Lead vehicle controller module 4 may be programmed to use the indicated proportional relationship to take a voltage value (e.g., from voltage signal 110) generated at any given time from accelerator pedal position sensor 5 of lead vehicle 2 and generate a proportional voltage value 115 for relative voltage ranges of controller module 3 of propulsion vehicle 1 as depicted for example in FIG. 3. Such value or values (e.g., proportional voltage value 115) may be transmitted from lead vehicle 2 (e.g., from controller 4) to propulsion vehicle 1 (e.g., controller 3) via one of the connections described above. For example, intercepted voltage signal 110 may be generated by pedal position sensor 5 and sent to lead vehicle controller module 4 which may send proportional voltage value 115 to transmitter 15 which may then forward this signal to receiver 6 which may then forward proportional voltage value 115 to controller module 3 of propulsion vehicle 1 as depicted for example, in FIG. 3. The voltage signals described may be sent via various wired or wireless connections and may be sent directly or indirectly between the indicated components. As indicated above, propulsion controller module 3 may act on the signal by increasing or lowering a speed of propulsion vehicle 1 or providing more or less force from propulsion vehicle 1 to lead vehicle 2.

In another example, a driver of lead vehicle 2 may optionally vary proportional voltage value 115 generated by controller module 4 in lead vehicle 2 and transmitted to controller module 3 to allow greater or lesser sensitivity of accelerator pedal position sensor 5 in lead vehicle 2 which would thereby direct a desired amount (according to the customization of the driver) of propulsion force generated by Propulsion vehicle 1 and applied to lead vehicle 2.

Vehicle controller 7 may be configured to cause an engine to idle (e.g., if diesel or gas powered) or not direct power to a drive motor (e.g., if electric) if it is desired that power not be driven to wheels of lead vehicle 2. For example, when propulsion vehicle 1 is applying a force to lead vehicle 2 it may not be desired for lead vehicle 2 to also be propelling itself via on-board drive mechanisms thereof such that it would be desirable for an internal combustion engine to be idled or an electric vehicle not to drive power to wheels thereof. For example, it may be desired for propulsion vehicle 1 to apply a force to lead vehicle 2 when lead vehicle 2 is equipped with regenerative braking such that an application of force by propulsion vehicle 1 to lead vehicle 2 may cause a battery of lead vehicle 2 to be charged as propulsion vehicle 1 pushes lead vehicle 2.

In an example, when voltage signal 110 from accelerator pedal position sensor 5 or proportional value 115 from controller module 4 in lead vehicle 2 are transmitted by controller module 4 to controller module 3 of propulsion vehicle 1 to cause propulsion vehicle 1 to be powered and applying a force to lead vehicle 2, a second set of voltage signals 120 may be sent from controller module 4 in lead vehicle 2 to vehicle controller 7 of the lead vehicle as depicted in FIG. 3, for example. Such second set of signals (e.g., voltage signals 120) may generally correspond with the minimum voltage values for the voltages ranges of accelerator pedal position sensor 5 specific to a make and model of lead vehicle 2 and such signals may cause lead vehicle 2 to not be self-propelling, i.e., an internal combustion engine to be idled or an electric vehicle not to drive power to wheels thereof.

For example, based on signal 120 (e.g., a neutral signal), vehicle controller 7 may interpret an accelerator pedal position (not shown) as such that the driver is not calling for any power to the drive system of lead vehicle 2 when propulsion vehicle is applying a force to lead vehicle 2. In the case of propulsion vehicle 1 providing such a force (i.e., wherein propulsion is not needed from lead vehicle 2 itself), an engine of lead vehicle 2 may be idled or not direct power to wheels thereof. In another example, controller module 4 in lead vehicle 2 may at times cause an engine of lead vehicle 2 to engage for reasons other for propulsion. In such a situation controller 4 may send a signal other than the minimum voltage values for the voltage ranges of accelerator pedal position sensor 5 to increase an engine speed (e.g., of an internal combustion engine of lead vehicle 2) for maintaining proper engine temperature (e.g., an engine of an internal combustion vehicle may be turned on for heating purposes when the ambient temperature is cold).

In the event that a driver of lead vehicle 2 desires to stop a propulsion force from being supplied by propulsion vehicle 1, the driver may tap a button (not shown) on or connected to lead vehicle controller module 4, or a touch screen button via a phone application remotely connected to lead vehicle controller 4 module, for example. Such a stop propulsion command may be sent via propelling signal 115, for example. When such a stop propulsion command is received by control module 4 in lead vehicle 2, a signal from control module 4 in lead vehicle 2 may revert to a default of sending voltage signal 100 to vehicle controller 7 of lead vehicle 2 (i.e., without sending signal 110 to controller module 4) such that lead vehicle 2 may be propelled by an on board engine (e.g., driving mechanism 8) and propulsion vehicle 1 may switch to a default “Follow Mode” in which propulsion vehicle 1 will only provide propulsion for itself (i.e., propulsion vehicle 1 will propel itself but will supply little or no force to lead vehicle 2). Thus, in the situation where a stop propulsion command has been sent by a driver, lead vehicle 2 may be propelled by a driving mechanism 25 (e.g. an electric or ICE motor) and propulsion vehicle 1 may be propelled by driving mechanism 8.

In a further example, instead of a neutral signal (e.g., signal 120) being sent from controller module 4 in lead vehicle 2 to vehicle controller 7 of the lead vehicle to cause engine of lead vehicle 2 to be idled or not direct power to wheels thereof, such a signal may cause power to be sent from such an engine to the wheels thereof in addition to the force being applied to lead vehicle 2 by propulsion vehicle 1. Such propulsion of lead vehicle 2 by an engine thereof and by propulsion vehicle 1 may occur in a situation where propulsion vehicle 1 may not be configured to provide a desired amount of propulsion force to lead vehicle 1. For example, in a situation where lead vehicle is a towing vehicle towing a trailer it may be desirable for propulsion vehicle 1 to provide supplemental force to drive lead vehicle 2 without providing all desired force to propel lead vehicle 2.

Controller module 3 in propulsion vehicle 1 may also send a continuous response signal to lead vehicle controller module 4 confirming that a connection between the controllers (e.g., controller module 3 and controller module 4 is made and a signal is being received from lead vehicle module 4.

Additionally, propulsion controller module 3 in propulsion vehicle 1 normally will transmit a responding signal 130 (e.g., via receiver 6 and transmitter 15) to controller module 4 in lead vehicle 2 indicating that a lead vehicle signal (e.g., signal 115 or signal 110) is being received from lead vehicle 2 as depicted in FIG. 3 for example. Therefore, if no responding signal (i.e., signal 130) is received by lead vehicle module 4 or such a responding signal (i.e., signal 130) indicates a fault, lead vehicle controller module 4 will revert to the default configuration of sending voltage signals 100 from accelerator pedal position sensor 5 in lead vehicle 2 to the vehicle controller 7 of lead vehicle 2 (e.g., without sending intercepted signal 110) and propulsion vehicle 1will revert to Follow Mode as described above. Similar to the situation described above where a stop propulsion command has been sent by a driver, if no responding signal is received by lead vehicle module 4 or such a responding signal (i.e., signal 130) indicates a fault, lead vehicle 2 may be propelled by driving mechanism 25 and propulsion vehicle 1 may be propelled by driving mechanism 8.

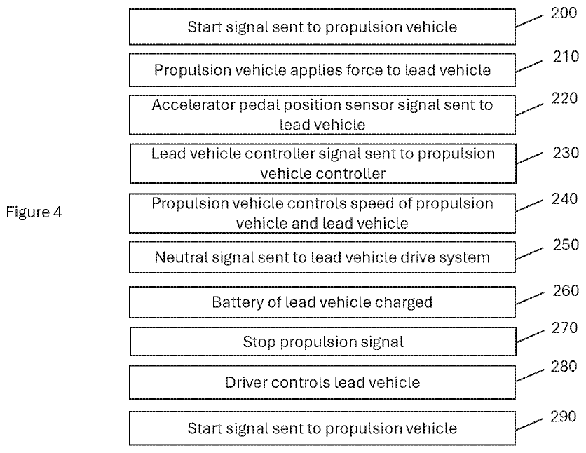

In an example depicted in FIG. 4, and referring to FIGS. 1-3, a driver may control a speed of lead vehicle 2 by adjusting a pressure on pedal 12 to control drive mechanism (e.g., an electric motor and drivetrain) in step 200. When lead vehicle 2 has been driven for a period of time to reduce a state of charge of a battery of drive mechanism 8, the driver may activate propulsion vehicle 1 via an integrated system of lead vehicle 2 or a smartphone application in step 210 where a start signal 113 may be sent to the propulsion vehicle 1 by the driver or automatically by controller 4 based on the state of charge of the battery in drive mechanism 8.

After receiving start signal 113, controller 3 may send responding signal 130 (e.g., via receiver 6 and transmitter 15) to controller module 4 in lead vehicle 2 indicating that start signal 113 or other signal (e.g., signal 115 or signal 110) is being received from lead vehicle 2 in step 210. Propulsion vehicle 1 may activate to apply a force to lead vehicle 2 in step 220. An amount of force applied by propulsion vehicle 1 to lead vehicle 2 and thus a speed of both vehicles may be controlled by a pressure applied to pedal 12 and sensed by accelerator pedal position sensor 5. Specifically, signal 110 sensed by accelerator sensor 5 may be intercepted by controller 4 in step 230 and propelling signal 115 may be sent by controller 4 to controller 3 in step 240 (e.g., via receiver 6 and transmitter 15). Controller 3 may control a speed of propelling vehicle 2 and thus lead vehicle based on signal 115 in step 250. The sending of propelling signal 115 may cause a neutral signal (e.g., signal 120) to be sent by controller 4 to controller 7 to provide the minimum voltage value for drive system operation or otherwise cause drive mechanism 8 to not apply power to drive lead vehicle 2 in step 260. The battery of driving mechanism 8 may be charged regeneratively as propelling vehicle 1 propels lead vehicle 2 in step 270. In step 280, the driver may cause a stop propulsion signal to be sent (e.g., via propelling signal 115), or such command automatically when the battery of drive mechanism 8 is charged to a desired amount as predetermined and programmed to controller 4 to cause propelling vehicle to revert to follow mode where propelling vehicle may not apply force to lead vehicle 2. In step 290 the driver may control lead vehicle by controlling a pressure on pedal 12 without controlling a force by propelling vehicle 1 which may follow but not apply a force to lead vehicle 2.

Vehicle controller 7 and controller module 4 may be separate controllers as described above or could be portion of a single controller (with the functions of vehicle controller 7 and controller module 4) which could be any type of computing unit capable of performing the steps described from a programmed set of instructions. Such controller or controllers may be included at the time of manufacture by an OEM or may be added after market.

The described control of a speed of propulsion vehicle 1 via an application (e.g., a smartphone or tablet application) may be as a supplement to or instead of controlling a speed of propulsion vehicle 1 via a user applying pressure to a pedal (e.g., pedal 12) when lead vehicle controller module 4 is connected to accelerator pedal position sensor 5 and vehicle controller 7. Such a speed of propulsion vehicle 1 may be controlled by instructions sent from an application (e.g., a mobile computing application such as smartphone or tablet application) to lead vehicle controller module 4 to be transmitted to propelling controller module 3 or directly to propelling controller module 3 via wireless communication protocols (e.g. cellular, BLUETOOTH or WIFI). For example, a speed controlled in this manner may generally be limited to maintaining near constant highway speeds in a “cruise control” option on a propulsion vehicle application on a downloaded driver's cell phone that connects to the propulsion vehicle controller via Bluetooth, cellular service or other wireless connection. The cruise control option on the application may provide the driver of lead vehicle 2 the option to select a desired speed setting by entering the desired speed into the application or via a verbal command to the application. The desired speed setting may be communicated to propulsion vehicle controller 3 which may seek to maintain the desired speed setting. Propulsion vehicle 1 may additionally be capable of adaptive speed control, similar to a function found in many newer vehicle models. To monitor the position of nearby vehicles, cameras, lidar, radar or other sensing equipment may be placed in propulsion vehicle 1 and may be mounted in an extendible post that protrudes up from propulsion vehicle 1 to a height above the lead vehicle to enable cameras of other sensing devices to view in front or either side of the lead vehicle

Lead vehicle 2 and propelling vehicle 1 are described above as being driven adjacent to each other and propelling vehicle 1 may be configured to provide a force to move or assist in a movement of lead vehicle 2. As indicated, propulsion vehicle 1 may be attachable to, or may be configured to provide such a force while contacting but not attached to, lead vehicle 2. Such attachment between lead vehicle 2 and propelling vehicle 1 may be via any number of mechanisms which allow force to be applied to lead vehicle 2 by propelling vehicle 1 when desired and for propelling vehicle 1 to follow lead vehicle 2 without providing such a force when desired.

While several aspects of the present invention have been described and depicted herein, alternative aspects may be effected by those skilled in the art to accomplish the same objectives. Accordingly, it is intended to cover all such alternative aspects as fall within the true spirit and scope of the invention.

It is to be understood that the above description is intended to be illustrative, and not restrictive. Numerous changes and modifications may be made herein by one of ordinary skill in the art without departing from the general spirit and scope of the disclosure as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the present disclosure has been described in detail in connection with only a limited number of embodiments, it should be readily understood that the present disclosure is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the disclosure may include only some of the described embodiments.

1. A method for use in propelling a vehicle comprising:
a first vehicle controller controlling a first driving mechanism of a first vehicle to control a movement of the first vehicle; and
a second vehicle controller of the first vehicle sending a propelling signal to a propelling vehicle controller of a second vehicle to cause the second vehicle controller to control a second driving mechanism to move the second vehicle to apply a force to the first vehicle.

2. The method of claim 1 further comprising the second vehicle controller receiving an intercepted signal from an accelerator sensor connected to the first vehicle controller and the second controller sending the propelling signal in response to the intercepted signal.

3. The method of claim 2 wherein the vehicle controller receiving the intercepted signal from the accelerator sensor comprises the accelerator sensor sending a signal to the first vehicle controller in response to an application of force to an accelerator connected to the accelerator sensor by a user.

4. The method of claim 1 further comprising the second vehicle controller sending a stop signal to the first vehicle controller to cause the first vehicle controller to control the first driving mechanism to stop the first driving mechanism from causing the first vehicle to move.

5. The method of claim 1further comprising the second vehicle controller receiving an intercepted signal from an accelerator sensor connected to the first vehicle controller and the second controller sending a stop signal to the first vehicle controller to cause the first vehicle controller to control the first driving mechanism to stop the first driving mechanism from causing the first vehicle to move.

6. The method of claim 1 further comprising the propelling vehicle controller sending a continuous response signal to the second vehicle controller to confirm that a connection exists between the propelling vehicle controller and the second vehicle controller, and wherein the second vehicle controller sends a go signal to the first vehicle controller to cause the first vehicle controller to control the first driving mechanism to cause the first vehicle to move when the continuous response signal is not received by the second vehicle controller.

7. The method of claim 1 further comprising the propelling vehicle controller controlling a second driving mechanism to move the second vehicle to avoid the second vehicle applying the force to the first vehicle in response to the second vehicle controller sending a stop signal to the propelling vehicle controller.

8. The method of claim 1 wherein the applying the force by the second vehicle to the first vehicle causes a charging of a battery of the first vehicle via a regenerative braking system of the first vehicle.

9. The method of claim 1 wherein the second vehicle controller of the first vehicle sending the propelling signal to the propelling vehicle controller of the second vehicle comprises the second vehicle controller sending the propelling signal to a transmitter of the first vehicle, the transmitter wirelessly sending the propelling signal to a receiver of the second vehicle and the receiver sending the propelling signal to the propelling vehicle controller of the second vehicle.

10. The method of claim 1 further comprising the second vehicle controller sending a stop signal to the first vehicle controller to cause the first vehicle controller to control the first driving mechanism to stop the first driving mechanism from causing the first vehicle to move when the second vehicle controller sends the propelling signal to the propelling vehicle controller to cause the second vehicle controller to control the second driving mechanism to move the second vehicle to apply the force to the first vehicle.

11. A system for use in propelling a vehicle:
an accelerator sensor for detecting a pressure on an accelerator by a user in a first vehicle;
the first vehicle having a first vehicle controller;
a second vehicle controller connectable between the accelerator sensor and the first vehicle controller of the first vehicle, the first vehicle controller configured to control a driving mechanism of the first vehicle;
a second vehicle having a propelling vehicle controller configured to control a driving mechanism of the second vehicle;
the propelling vehicle controller connected to the second vehicle controller;
the second vehicle configured to apply a force to the first vehicle to propel the first vehicle;
the second vehicle controller configured to send a communication to the propelling vehicle controller in response to receiving a signal from accelerator sensor detecting a pressure on the accelerator by the user; and
the propelling vehicle controller configured to control the driving mechanism of the second vehicle to change a speed of the second vehicle in response to the propelling vehicle controller receiving the communication from the second vehicle controller.

12. The system of claim 11 wherein the first vehicle comprises a transmitter connected to the second vehicle controller and the second vehicle comprises a receiver connected to the propelling vehicle controller, the transmitter configured to receive the communication from the second vehicle controller and wirelessly send the communication to the receiver.

13. The system of claim 11 wherein the second vehicle is attachable to the first vehicle and the propelling vehicle controller is configured to control the driving mechanism of the second vehicle to apply the force to the first vehicle to propel the first vehicle when the second vehicle is connected to the first vehicle.

14. The system of claim 11 wherein the second vehicle controller is configured to send a stop signal to the first vehicle controller to cause the first vehicle controller to control the first driving mechanism to stop the first driving mechanism from causing the first vehicle to move when the second vehicle controller sends the propelling signal to the propelling vehicle controller to cause the second vehicle controller to control the second driving mechanism to move the second vehicle to apply the force to the first vehicle.

15. The system of claim 11 wherein the first vehicle comprises an electric vehicle having a regenerative electric drive mechanism for charging a battery thereof, and wherein the regenerative electric drive mechanism is configured to electrically charge the battery when the second vehicle applies the force to the first vehicle.

16. A method for use in propelling a vehicle comprising:
a first vehicle controller controlling a first driving mechanism of a first vehicle to control a movement of the first vehicle;
a user sending a propelling signal to a propelling vehicle controller of a second vehicle via a wireless signal from an application of a mobile computing device to cause the second vehicle controller to control a second driving mechanism to move the second vehicle to apply a force to the first vehicle.

17. The method of claim 16 wherein the sending the propelling signal to the propelling vehicle controller causes the propelling vehicle controller to control a speed of the first vehicle at a constant speed.
